(19) United States
(12) Patent Application Publication
(10) Pub. No.: US 2023/0132630 A1
(43) Pub. Date: May 4, 2023

(54) APPARATUS AND METHOD WITH NEURAL NETWORK TRAINING BASED ON KNOWLEDGE DISTILLATION

(71) Applicants: SAMSUNG ELECTRONICS CO., LTD., Suwon-si (KR); Seoul National University R&DB Foundation, Seoul (KR)

(72) Inventors: Eunhee KANG, Yongin-si (KR); Minsoo KANG, Seoul (KR); Bohyung HAN, Seoul (KR); Sehwan KI, Hwaseong-si (KR); HYONG EUK LEE, Suwon-si (KR)

(73) Assignees: SAMSUNG ELECTRONICS CO., LTD., Suwon-si (KR); Seoul National University R&DB Foundation, Seoul (KR)

(21) Appl. No.: 17/862,779

(22) Filed: Jul. 12, 2022

(30) Foreign Application Priority Data
Nov. 1, 2021 (KR) 10-2021-0148167
Feb. 11, 2022 (KR) 10-2022-0018390

(51) Int. Cl. G06N 3/04; G06N 3/08

(52) U.S. Cl. CPC G06N 3/0454; G06N 3/08

(57) ABSTRACT

A method includes: generating, based on a student network result of an implemented student network provided with an input, a sample corresponding to a distribution of an energy-based model based on the student network result and a teacher network result of an implemented teacher network provided with the input; training model parameters of the energy-based model to decrease a value of the energy-based model, based on the teacher network result and the student network result; and training the implemented student network to increase the value of the energy-based model, based on the sample and the student network result.

### CROSS-REFERENCE TO RELATED APPLICATIONS

This application claims the benefit under 35 USC § 119(a) of Korean Patent Application No. 10-2021-0148167, filed on Nov. 1, 2021, in the Korean Intellectual Property Office, and Korean Patent Application No. 10-2022-0018390, filed on Feb. 11, 2022, in the Korean Intellectual Property Office, the entire disclosures of which are incorporated herein by reference for all purposes.

### BACKGROUND

### 1. Field

The following description relates to an apparatus and method with a network training based on knowledge distillation.

### 2. Description of Related Art

Knowledge distillation may be a transfer of knowledge of a pretrained teacher network to a student network to be practically applied by minimizing the size of the network.

If there are a number of parameters of a deep learning model, and a large number of computations, it may be possible to more accurately reach a result corresponding to a purpose of a corresponding model. However, due to a reduction in the size of the network, a network capable of deriving a similar performance, even with fewer resources, may be provided in a device with fewer computing resources.

For knowledge distillation, in existing studies, a mean squared error (MSE) loss and an L2 norm may be minimized, or a cosine similarity may be maximized after matching the number of channels of the student network to the number of channels of the teacher network with 1×1 convolution, in order to reduce a distance between intermediate features of the student network and the teacher network.

In addition, knowledge distillation for a final output may reduce the L2 norm between the teacher network and the student network, or minimize a structural similarity loss, a perceptual loss, and a style loss.

A general variational information distillation (VID) for knowledge transfer may optimize a variational lower bound by using a fully-factorized Gaussian distribution for a distribution of an objective function q(|t).

FIG. 1 illustrates an example of a performance of a student network modeled by Gaussian according to a related art.

If an output follows an image, a distribution of the image may not follow a general Gaussian distribution, and thus, a blurred image may be generated when training is performed by using a fully-factorized Gaussian distribution like VID.

As illustrated in FIG. 1, if the image is restored using a trained student network based on the Gaussian distribution for an input image that does not follow the Gaussian distribution, the image may not fully be restored.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method includes: generating, based on a student network result of an implemented student network provided with an input, a sample corresponding to a distribution of an energy-based model based on the student network result and a teacher network result of an implemented teacher network provided with the input; training model parameters of the energy-based model to decrease a value of the energy-based model, based on the teacher network result and the student network result; and training the implemented student network to increase the value of the energy-based model, based on the sample and the student network result.

The training of the model parameters may include training the model parameters to decrease a difference between mutual information of the implemented teacher network and the implemented student network, and a variational lower bound of the mutual information.

The training of the implemented student network may include training the implemented student network to increase a variational lower bound of mutual information of the implemented teacher network and the implemented student network.

The training of the implemented student network may include training the implemented student network to increase the value of the energy-based model based on the trained model parameters, based on the sample and the student network result.

The training of the model parameters and the training of the implemented student network may be repeatedly performed.

While the training of the model parameters and the training of the implemented student network are repeatedly performed, the model parameters may be trained based on another student network result of the trained student network provided with the input.

The energy-based model may be represented by

$${q}_{θ} ( t \vert s ) = \frac{1}{{Z}_{θ} ( s )} \cdot exp ( - {E}_{θ} ( t , s ) ) ,$$

wherein E_{θ} denotes an energy function parameterized by the student network, (t, s) denotes an input of the implemented teacher network and the implemented student network, and Z_{θ} denotes a partition function representing a sum of probabilities that each of inputs of the implemented student network is present.

The generating of the sample may include generating the sample based on a Markov chain Monte Carlo (MCMC) scheme.

The implemented teacher network and the implemented student network may include an image generation network.

A non-transitory computer-readable storage medium may store instructions that, when executed by a processor, cause the processor to perform any one or all of methods herein.

In another general aspect, a method, includes: applying an input to at least one image generation network; and outputting an image based on the at least one image generation network, wherein the at least one image generation network is trained by a knowledge distillation scheme using an energy-based model.

The at least one image generation network may include a first type network trained by a first knowledge distillation scheme using the energy-based model, and a second type network trained by a second knowledge distillation scheme using a Gaussian distribution.

Each of the at least one image generation network may be determined to be one of the first type network and the second type network based on either one or both of diversity of colors and textures comprised in an image generated by a corresponding image generation network.

The at least one image generation network corresponding to a student network may be trained by: generating, based on a student network result of the student network provided with a network input, a sample corresponding to a distribution of the energy-based model based on the student network result and a teacher network result of a teacher network provided with the network input; training model parameters of the energy-based model to decrease a value of the energy-based model, based on the teacher network result and the student network result; and training the student network to increase the value of the energy-based model, based on the sample and the student network result.

The training of the student network may include training the student network to increase the value of the energy-based model based on the trained model parameters, based on the sample and the student network result.

In another general aspect, an apparatus includes one or more processors, and a memory configured to store instructions. The one or more processors are configured to execute the instructions, which configures the one or more processors to perform: generating, based on a student network result of an implemented student network provided with an input, a sample corresponding to a distribution of an energy-based model based on the student network result and a teacher network result of an implemented teacher network provided with the input; training model parameters of the energy-based model to decrease a value of the energy-based model, based on the teacher network result and the student network result; and training the implemented student network to increase the value of the energy-based model, based on the sample and the student network result.

The training of the implemented student network may include training the implemented student network to increase the value of the energy-based model based on the trained model parameters, based on the sample and the student network result.

The training of the model parameters and the training of the student network may be repeatedly performed.

While the training of the model parameters and the training of the implemented student network are repeatedly performed, the model parameters may be trained based on another student network result of the trained student network provided with the input.

In another general aspect, an apparatus includes one or more processors, and a memory configured to store instructions. The one or more processors are configured to execute the instructions, which configures the one or more processors to perform: applying an input to at least one image generation network; and outputting an image based on the at least one image generation network, wherein the at least one image generation network is trained by a knowledge distillation scheme using an energy-based model.

The at least one image generation network may include a first type network trained by a first knowledge distillation scheme using the energy-based model, and a second type network trained by a second knowledge distillation scheme using a Gaussian distribution.

Each of the at least one image generation network may be determined to be one of the first type network and the second type network based on either one or both of diversity of colors and textures comprised in an image generated by a corresponding image generation network.

Other features and aspects will be apparent from the following detailed description, the drawings, and the claims.

### BRIEF DESCRIPTION OF THE DRAWINGS

FIG. 1 illustrates an example of a performance of a student network modeled by Gaussian according to a related art.

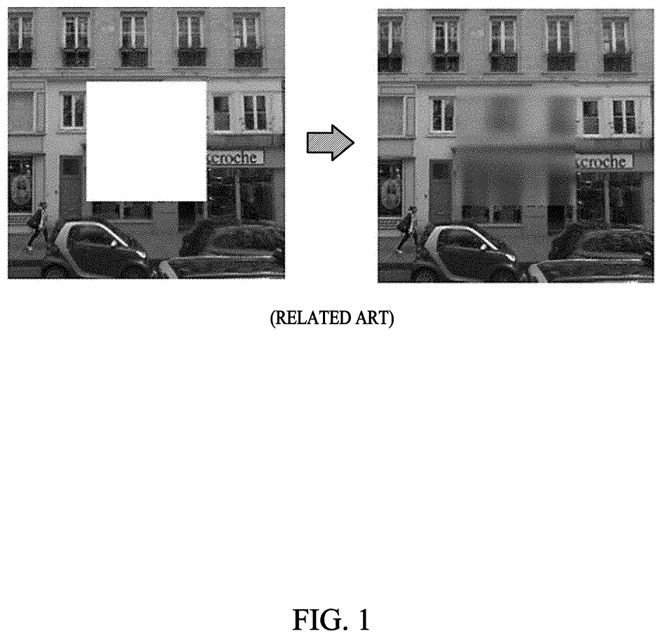

FIG. 2 illustrates an example of a network training method based on knowledge distillation.

FIG. 3 is a flowchart illustrating an example of a network training method based on knowledge distillation.

FIG. 4 illustrates an example of a configuration of an apparatus for network training based on knowledge distillation.

FIG. 5 illustrates an example of a performance of a trained network.

FIG. 6 is a flowchart illustrating an example of an image generating method.

FIG. 7 illustrates an example of an image generating method based on different networks depending on a type of an image in an image generating apparatus.

FIG. 8 illustrates an example of a configuration of an image generating apparatus.

FIG. 9 illustrates an example of an energy-based model utilized for channel pruning.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

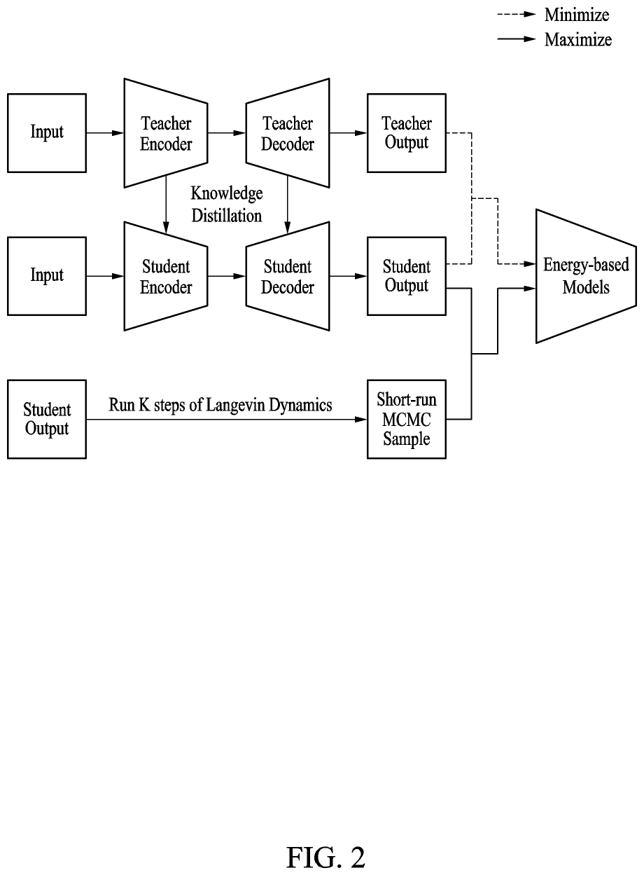

FIG. 2 illustrates an example of a network training method based on knowledge distillation.

As illustrated in FIG. 2, when an input is received, the input may pass through each of a teacher network and a student network, and outputs (a student output and a teach output) of a network may be extracted.

Subsequently, samples may be calculated from the student output by running k steps of Langevin dynamics. In an example, a sample may be calculated based on Markov chain Monte Carlo (MCMC). The MCMC may be an algorithm that extracts samples with a desired distribution through several tries by randomly designating the first sample, and then recommending a next sample by the first sample based on statistical characteristics.

An energy-based model and the student network may be trained such that a pair of the teacher output and the student output decreases an output of an energy-based function, and a pair of an MCMC sample and the student output increases the output of the energy-based function.

According to an example embodiment, the energy-based model and the student network may be intersectionally trained in the scheme.

In general, mutual information between high-dimensional distributions may be determined based on Equation 1 below.

$$\begin{matrix}I ( T ; S ) = H ( T ) - H ( T \vert S ) \\ = H ( T ) + {𝔼}_{s , t} [ log q ( t \vert s ) ] + {D}_{KL} ( p ( t \vert s ) \vert \vert q ( t \vert s ) ) \\ \geq H ( T ) + {𝔼}_{s , t} [ log q ( t \vert s ) ] {=}^{Δ} \tilde{I} ( T ; S )\end{matrix} \qquad Equation 1$$

I(T; S) may be mutual information between distributions of a teacher network and a student network. H(T) denotes an entropy of the teacher network, p(t|s) denotes a conditional distribution, q(t|s) denotes an approximate distribution of p(t|s), and E denotes an expected value.

In an example, q(t|s) may be modeled by the energy-based model according to an image region.

In Equation 1, p(t|s) may be an ideal function, and may be difficult to be actually derived, and thus, p(t|s) may be optimized based on Ĩ(T; S) that is a distribution lower bound, through an approximation to q(t|s).

In an example, unlike variational information distillation (VID), described above, modeling may be performed by the energy-based model that considers dependence on a spatial dimension and is modeled to a more flexible distribution. The energy-based model may be modeled as shown in Equation 2 below.

$${q}_{θ} ( t \vert s ) = \frac{1}{{Z}_{θ} ( s )} \cdot exp ( - {E}_{θ} ( t , s ) ) \qquad Equation 2$$

In Equation 2, E_{θ} may be an energy function that is parameterized by a network, and receives (t, s) as an input, and an output may be represented by a scalar value. Z_{θ} may be a partition function representing a sum of probabilities that each of all inputs of the student network is present. The probability of being in a state of having energy E may be proportional to exp(E), however since a corresponding value itself may not be a probability, a probability value may be obtained by dividing the corresponding value by the sum of probabilities that each of all inputs modeling may be performed by using a deep neural network (DNN).

The energy-based model may be trained to decrease D_{KL}(p(t|s)∥q(t|s)) that is a difference between actual mutual information and a variational lower bound, and the student network may be trained to improve the mutual information between an output distribution of the teacher network and an output distribution of the student network. A training method will be described in detail later.

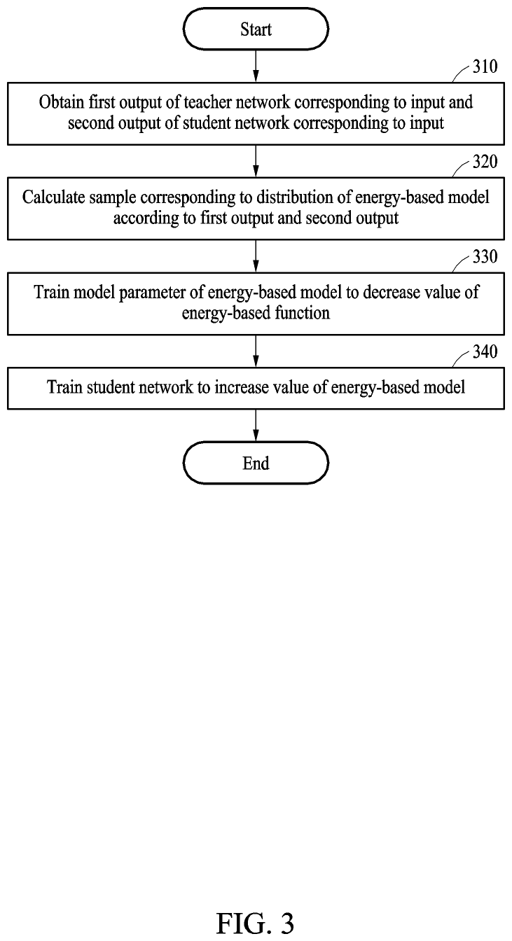

FIG. 3 is a flowchart illustrating an example of a network training method based on knowledge distillation.

A network training method based on knowledge distillation, according to an example, may be performed based on an apparatus including enough specifications to train a network.

In operation 310, when an input is received, the apparatus may obtain a first output of a teacher network corresponding to the input, and a second output of a student network corresponding to the input.

In operation 320, a sample corresponding to a distribution of an energy-based model according to the first output and the second output may be calculated based on the second output.

In an example, an MCMC scheme may be utilized to calculate the sample.

In operation 330, a model parameter of the energy-based model may be trained, based on the first output and the second output, to decrease a value of an energy-based function.

In an example, the model parameter of the energy-based model may be trained to decrease a difference between mutual information of the teacher network and the student network and a variational lower bound of the mutual information.

As described above, the energy-based model may be optimized to decrease D_{KL}(p(t|s)∥q(t|s)).

$$\begin{matrix}{min}_{θ} {D}_{KL} ( p ( t \vert s ) \vert \vert {q}_{θ} ( t \vert s ) ) ⟺ {min}_{θ} {𝔼}_{s , t} [ log \frac{p ( t \vert s )}{{q}_{θ} ( t \vert s )} ] \\ ⟺ {min}_{θ} {𝔼}_{s , t} [ - log {q}_{θ} ( t \vert s ) ]\end{matrix} \qquad Equation 3$$

In Equation 3, an expected value may be a value that is calculated for an actual joint distribution p_{data}(s, t). A gradient for decreasing a target value by using a gradient descent for a model parameter θ′ of the energy-based model may be obtained as shown in Equation 4 below.

$$\begin{matrix}\frac{\partial }{\partial θ} {𝔼}_{( s , t ) \sim {p}_{data}} [ - log {q}_{θ} ( t \vert s ) ] = \frac{\partial }{\partial θ} {𝔼}_{( s , t ) \sim {p}_{data}} [ {E}_{θ} ( t , s ) - log {Z}_{θ} ( s ) ] \\ = {𝔼}_{( s , t ) \sim {p}_{data}} [ \frac{\partial {E}_{θ} ( t , s )}{\partial θ} ] - {𝔼}_{s \sim {p}_{data}} {𝔼}_{t \sim {q}_{θ} ( t \vert s )} [ \frac{\partial {E}_{θ} ( t , s )}{\partial θ} ]\end{matrix} \qquad Equation 4$$

Values that are sampled from a distribution of q_{θ}(t|s) may be required to calculate [symbol] _{t˜q}_{_{θ}}_{(t|s)}(⋅), and in order to obtain the values, a sample may be calculated using a scheme, such as MCMC and the like, as described above. Langevin dynamics may be utilized for sampling, and repeated samplings may be performed, as shown in Equation 5 below.

$${\tilde{t}}^{k} = {\tilde{t}}^{k - 1} - \frac{λ}{2} {∇}_{t} {E}_{θ} ( {\tilde{t}}^{k - 1} , s ) + {w}^{k} , {w}^{k} \sim 𝒩 ( 0 , λ ) \qquad Equation 5$$

Theoretically, if k→∞ and λ→0, there may be convergence on a value of a sample from the distribution of q_{θ}(t|s). Since a very large calculation is needed, a sample receiving determined k steps of Langevin dynamics may be approximate to a sample from the distribution of q_{θ}(t|s). In this example, a data distribution, \tilde{t}^{K}, in a previous epoch, and random noise may be used as [symbol] that is an initial value of the corresponding sample. In an example, the sample may be initialized to an output s of the student network.

By introducing the energy-based model, according to an example, the performance of the student network may improve. In this case, the performance of the student network may be improved through training to increase a lower bound of the mutual information. Furthermore, since the output of the student network may be used when an image is generated, an additional cost may not be incurred.

In operation 340, the apparatus may train the student network to increase a value of the energy-based model, based on the sample and the second output.

As described above, the student network may be trained to increase a variational lower bound of the mutual information of the teacher network and the student network. That is, the student network may be trained to increase a value of the energy-based model according to a trained model parameter, based on the sample and the second output.

First, a process of training a student network G^{s} may be represented by Equation 6 below.

$${max}_{{ϕ}_{s}} H ( T ) + {𝔼}_{s , t} [ log q ( t \vert s ) ] ⟺ {max}_{{ϕ}_{s}} {𝔼}_{s , t} [ log q ( t \vert s ) ] \qquad Equation 6$$

As shown in Equation 6, a variational lower bound may be maximized. In this example, entropies of a teacher network G^{T} and an output T may be irrelevant to a parameter ϕ_{S} of the student network, and thus, equivalence may be established. A gradient for training a gradient ascent to maximize a target value according to an example may be calculated, as shown in Equation 7 below.

$$\begin{matrix}\frac{\partial }{\partial {ϕ}_{s}} {𝔼}_{s , t} [ - log {q}_{θ} ( t \vert s ) ] = \frac{\partial }{\partial {ϕ}_{s}} {𝔼}_{s , t} [ {E}_{θ} ( t , s ) - log {Z}_{θ} ( s ) ] \\ = \frac{\partial }{\partial {ϕ}_{s}} {𝔼}_{x \sim {p}_{data}} [ {E}_{θ} ( {G}^{T} ( x ; {ϕ}_{t} ) , {G}^{S} ( x ; {ϕ}_{s} ) ) ] - \frac{\partial }{\partial {ϕ}_{s}} {𝔼}_{x \sim {p}_{data}} [ log {Z}_{θ} ( {G}^{S} ( x ; {ϕ}_{s} ) ) ] \\ = {𝔼}_{x \sim {p}_{data}} [ \frac{\partial }{\partial {ϕ}_{s}} {E}_{θ} ( {G}^{T} ( x ; {ϕ}_{t} ) , {G}^{S} ( x ; {ϕ}_{s} ) ) ] - {𝔼}_{x \sim {p}_{data}} {𝔼}_{t \sim {q}_{θ} ( t \vert {G}^{S} ( x ; {ϕ}_{s} ) )} [ \frac{\partial }{\partial {ϕ}_{s}} {E}_{θ} ( t , {G}^{S} ( x ; {ϕ}_{s} ) ) ]\end{matrix} \qquad Equation 7$$

In Equation 7, since a sampling process from a distribution of q_{θ}((t|G^{S}(x; ϕₛ)) is previously calculated as a value of a sample obtained by utilizing Langevin dynamics when the energy-based model is trained, a gradient may be obtained without incurring additional cost.

In an example, while operations 330 and 340 are repeatedly performed, a model parameter may be trained based on the other output that is output from a trained student network corresponding to the input.

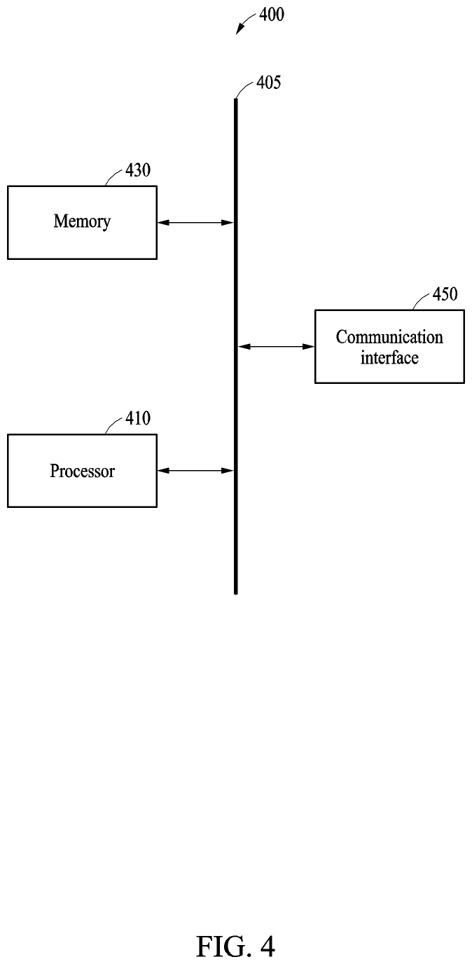

FIG. 4 illustrates an example of a configuration of an apparatus for network training based on knowledge distillation.

An apparatus 400, according to an example, may include a processor 410, a memory 430, and a communication interface 450. The processor 410, the memory 430, and the communication interface 450 may communicate with each other via a communication bus 405.

The processor 410, according to an example, may perform a network training method based on knowledge distillation.

The network training method based on knowledge distillation may include receiving an input, obtaining a first output of a teacher network corresponding to the input, obtaining a second output of a student network corresponding to the input, calculating, based on the second output, a sample corresponding to a distribution of an energy-based model according to the first output and the second output, training a model parameter of the energy-based model to decrease a value of the energy-based model, based on the first output and the second output, and training the student network to increase the value of the energy-based model, based on the sample and the second output.

The memory 430 may be a volatile memory or a non-volatile memory, and the processor 410 may execute a program and control the apparatus 400. Program code executed by the processor 410 may be stored in the memory 430.

The apparatus 400 may be connected to an external device (e.g., a personal computer or a network) via an input and output device (not illustrated) to exchange data. The apparatus 400 may be equipped on various computing devices and/or systems, such as smartphones, tablets, laptops, desktop computers, television, wearable devices, security systems, smart home systems, smart home systems, etc.

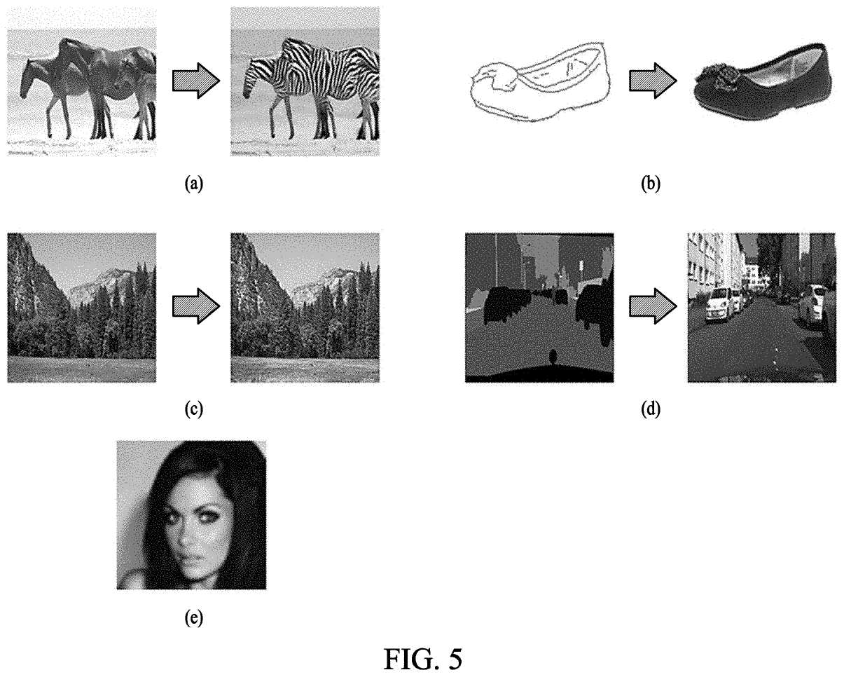

FIG. 5 illustrates an example of a performance of a trained network.

In an example, a trained student network may be utilized as an image generation network. FIGS. 5A through 5E may be examples of the trained student network applied to generate an image, and a performance of the trained student network will be described.

In an example, FIG. 5A may be a task in which colors and textures are very limited. For example, FIG. 5A may be an example of a pattern of a horse being changed to a zebra pattern.

FIG. 5B may be a task where colors vary, and textures are limited. For example, FIG. 5B may be an example of the textures and the colors of a shoe being expressed in a state where an edge of the corresponding shoe is given.

FIG. 5C may be a case in which colors are limited, and an image is a nature image. For example, FIG. 5C may be an example of a change of season of a natural landscape, for example, a change of an image that expresses summer to an image that expresses winter.

FIG. 5D may be a task of expressing a real nature image. In this example, since colors and textures are not limited, the degree of freedom for expressing a nature image may be high.

FIG. 5E may be a task in which colors and textures have a higher degree of freedom compared to FIG. 5A.

For the above-described examples, an image may be generated using an image generation network trained by the method described with reference to FIGS. 2 through 4.

As a result of an application of an example, if there is a limitation, as illustrated in FIG. 5A or 5E, a performance of a network may be higher compared to a performance of a network trained based on a general VID.

A student network trained by an energy-based model, according to an example, may take a long time to be trained compared to VID. In an example, an image generating apparatus that selectively uses the image generation network trained by VID and the image generation network trained by the energy-based model may be provided.

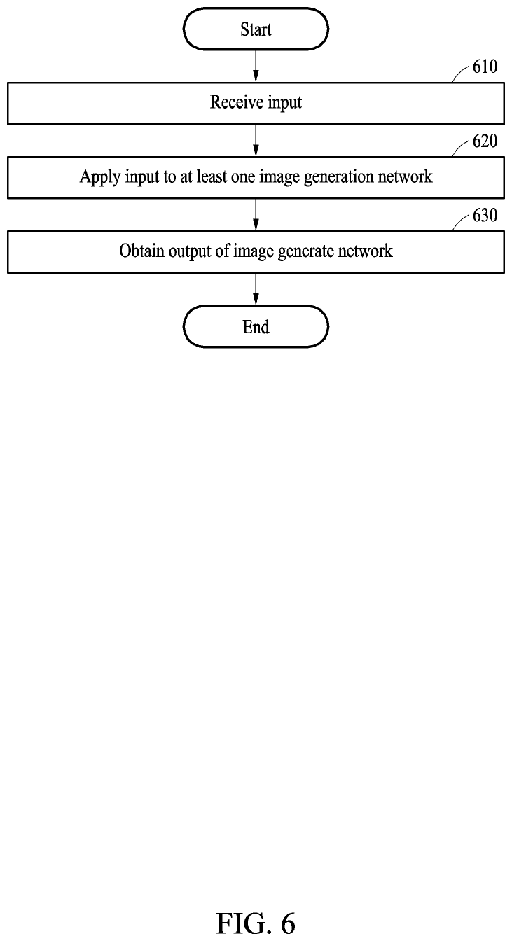

FIG. 6 is a flowchart illustrating an example of an image generating method.

In operation 610, an image generating apparatus may receive an input. In an example, the input may be a subject of an image to be generated.

In operation 620, the image generating apparatus may apply the input to at least one image generation network.

In an example, the image generation network may include at least two or more networks, and at least one of the networks may be a student network trained by a knowledge distillation scheme based on the energy-based model described above, and at least one of the networks may be a student network trained by a knowledge distillation scheme based on a Gaussian distribution.

In an example, an input image may be divided into a plurality of regions. For example, a region in which an image object is included may be divided from a background, based on a texture, or based on light and shade in the image. Each region may be divided into different sizes.

According to an example, the image generating apparatus may input each of the divided regions by one network based on at least one diversity of colors and textures that correspond to a corresponding region.

For example, a region in which a constraint of an image to be generated is greater than a reference, such as a region in which patterns or colors are changed to designated patterns or colors, may generate an image by using an image generation network trained by a knowledge distillation scheme based on the energy-based model.

In operation 630, the image generating apparatus may obtain an image that is output by the image generation network.

For example, a final image that sums the generated images corresponding to all regions may be obtained by substituting images that are output by each image generation network into a corresponding region.

A part of the regions of the obtained image may be generated by the image generation network trained by a knowledge distillation scheme based on the energy-based model.

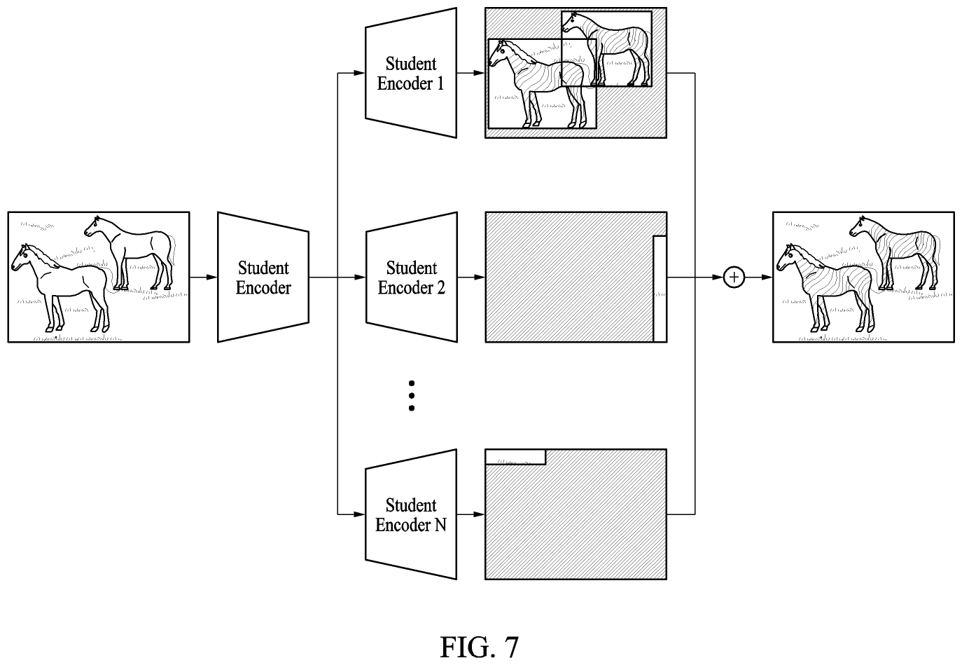

FIG. 7 illustrates an example of an image generating method based on different networks depending on a type of an image in an image generating apparatus.

In an example, an operating scheme of the image generating apparatus described with reference to FIG. 6 is illustrated.

In the image generating apparatus, according to an example, a region, in which a constraint of an image to be generated is greater than a reference, such as a region in which patterns or colors of an input image are changed to designated patterns or colors, may generate an image by using an image generation network trained by a knowledge distillation scheme based on an energy-based model.

As illustrated in FIG. 7, an example may be a process of generating an image of staining on a horse included in the image. The input image may be a nature image that includes a horse that is a subject to be deformed, and the image generating apparatus may extract a region of a horse recognized from the input image to input the corresponding region to the image generation network (Student Decoder 1) trained by a knowledge distillation scheme based on the energy-based model.

The region, according to an example, may be approximated to a quadrangle, and may be divided such that all regions in the image are covered. For example, Student Decoder 2 through Student Decoder N may be image generation networks trained by a knowledge distillation scheme based on a Gaussian distribution, and the image may be generated based on the trained networks on the region corresponding to a nature image and the like.

Images that are output from each image generation network may be substituted into the corresponding regions and may be summed. As described in an example, an output image in which a horse is stained may be obtained corresponding to the input image.

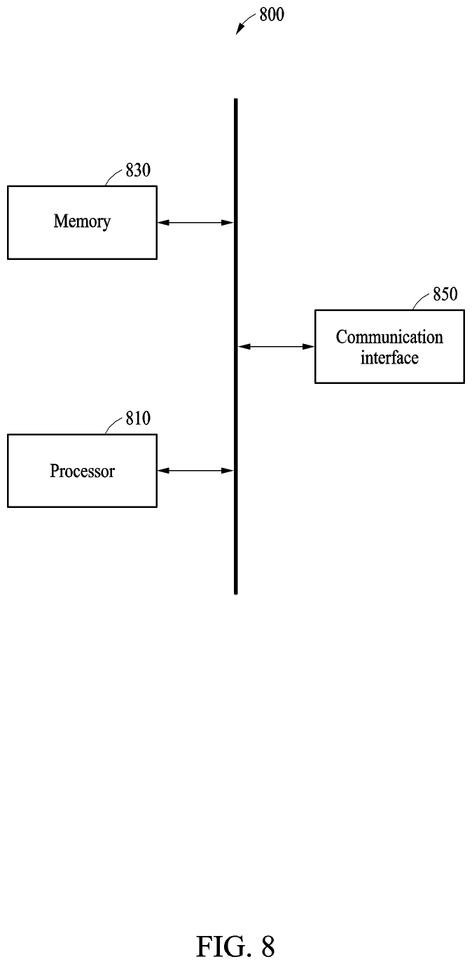

FIG. 8 illustrates an example of a configuration of an image generating apparatus.

An image generating apparatus 800, according to an example, may include a processor 810, a memory 830, and a communication interface 850. The processor 810, the memory 830, and the communication interface 850 may communicate with each other via a communication bus 805.

The processor 810, according to an example, may perform an image generating method by using a network trained based on knowledge distillation.

The image generating method may include receiving an input, applying the input to at least one image generation network, and outputting an image that is output by the image generation network. In an example, at least part of the image generation network may be trained by a knowledge distillation scheme using an energy-based model.

The memory 830 may include a volatile memory or a non-volatile memory, and the processor 810 may execute a program and control the image generating apparatus 800. Program code that is executed by the processor 810 may be stored in the memory 830.

The image generating apparatus 800 may be connected to an external device (e.g., a personal computer or a network) via an input and output device (not illustrated) to exchange data. The image generating apparatus 800 may be equipped on various computing devices and/or systems, such as smartphones, tablets, laptops, laptops, computers, television, wearable devices, security systems, smart home systems, and the like.

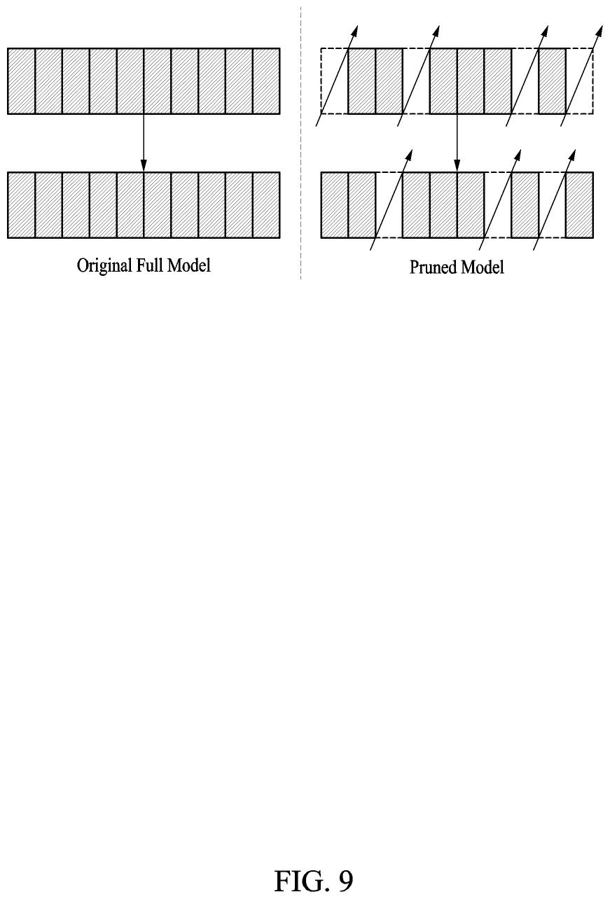

FIG. 9 illustrates an example of an energy-based model utilized for channel pruning.

In an example, when training of a student network is completed, an energy-based model may be utilized for channel pruning of a network. For this utilization, a posterior distribution p(t|s) may be approximate, as shown in Equation 8 below.

$$\begin{matrix}{arg min}_{ϕ} {𝔼}_{s , t} [ - log p ( s \vert t ; ϕ ) ] = {arg min}_{ϕ} {𝔼}_{s , t} [ - log p ( t \vert s ; ϕ ) - log p ( s ; ϕ ) ] \\ \approx {arg min}_{ϕ} {𝔼}_{s , t} [ - log {q}_{θ} ( t \vert s ; ϕ ) - log p ( s ; ϕ ) ] \\ \approx {arg min}_{ϕ} {𝔼}_{s , t} [ - log {q}_{θ} ( t \vert s ; ϕ ) - μ D ( s ; ϕ ) ]\end{matrix} , \qquad Equation 8$$

In an example, a discriminator D(⋅), and the energy-based model may be utilized to be approximate.

In addition, if a level of change of a final score is defined when an importance of each channel, for example, a corresponding channel, is pruned, an approximation may be performed as shown in Equation 9 below.

$$I ( {ϕ}_{c} ) = {ϕ}_{c} * ( {𝔼}_{s , t} [ \frac{\partial }{\partial {ϕ}_{c}} {E}_{θ} ( t , s ) ] - {𝔼}_{s} {𝔼}_{t \sim {q}_{θ} ( t \vert s ; ϕ )} [ \frac{\partial }{\partial {ϕ}_{c}} {E}_{θ} ( t , s ) ] - {μ𝔼}_{s} [ \frac{\partial D ( s ; ϕ )}{\partial {ϕ}_{c}} ] ) \qquad Equation 9$$

In Equation 9, the approximation may be performed by using first-order Taylor approximation.

A final network may be pruned, and a fine tuning may be proceeded by pruning a relatively less important channel, as illustrated in FIG. 9, to meet a target budget based on a first defined priority I(⋅).

The teacher encoder, student encoder, teacher decoder, student decoder, and apparatus in FIG. 2-9 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 2-9 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented method, the method comprising:
generating, based on a student network result of an implemented student network provided with an input, a sample corresponding to a distribution of an energy-based model based on the student network result and a teacher network result of an implemented teacher network provided with the input;
training model parameters of the energy-based model to decrease a value of the energy-based model, based on the teacher network result and the student network result; and
training the implemented student network to increase the value of the energy-based model, based on the sample and the student network result.

2. The method of claim 1, wherein the training of the model parameters comprise training the model parameters to decrease a difference between mutual information of the implemented teacher network and the implemented student network, and a variational lower bound of the mutual information.

3. The method of claim 1, wherein the training of the implemented student network comprises training the implemented student network to increase a variational lower bound of mutual information of the implemented teacher network and the implemented student network.

4. The method of claim 1, wherein the training of the implemented student network comprises training the implemented student network to increase the value of the energy-based model based on the trained model parameters, based on the sample and the student network result.

5. The method of claim 1, wherein the training of the model parameters and the training of the implemented student network are repeatedly performed.

6. The method of claim 5, wherein, while the training of the model parameters and the training of the implemented student network are repeatedly performed, the model parameters are trained based on another student network result of the trained student network provided with the input.

7. The method of claim 1, wherein the energy-based model is represented by
$${q}_{θ} ( t \vert s ) = \frac{1}{{Z}_{θ} ( s )} \cdot exp ( - {E}_{θ} ( t , s ) ) ,$$
wherein E_{θ} denotes an energy function parameterized by the student network, (t, s) denotes an input of the implemented teacher network and the implemented student network, and Z_{θ} denotes a partition function representing a sum of probabilities that each of inputs of the implemented student network is present.

8. The method of claim 1, wherein the generating of the sample comprises generating the sample based on a Markov chain Monte Carlo (MCMC) scheme.

9. The method of claim 1, wherein the implemented teacher network and the implemented student network comprise an image generation network.

10. A non-transitory computer-readable storage medium storing instructions that, when executed by a processor, cause the processor to perform the method of claim 1.

11. A processor-implemented method, comprising:
applying an input to at least one image generation network; and
outputting an image based on the at least one image generation network,
wherein the at least one image generation network is trained by a knowledge distillation scheme using an energy-based model.

12. The method of claim 11, wherein the at least one image generation network comprises:
a first type network trained by a first knowledge distillation scheme using the energy-based model; and
a second type network trained by a second knowledge distillation scheme using a Gaussian distribution.

13. The method of claim 12, wherein each of the at least one image generation network is determined to be one of the first type network and the second type network based on either one or both of diversity of colors and textures comprised in an image generated by a corresponding image generation network.

14. The method of claim 11, wherein the at least one image generation network corresponding to a student network is trained by:
generating, based on a student network result of the student network provided with a network input, a sample corresponding to a distribution of the energy-based model based on the student network result and a teacher network result of a teacher network provided with the network input;
training model parameters of the energy-based model to decrease a value of the energy-based model, based on the teacher network result and the student network result; and
training the student network to increase the value of the energy-based model, based on the sample and the student network result.

15. The method of claim 14, wherein the training of the student network comprises training the student network to increase the value of the energy-based model based on the trained model parameters, based on the sample and the student network result.

16. A non-transitory computer-readable storage medium storing instructions that, when executed by a processor, cause the processor to perform the method of claim 10.

17. An apparatus, the apparatus comprising:
one or more processors; and
a memory configured to store instructions,
wherein the one or more processors are configured to execute the instructions, which configures the one or more processors to perform:
generating, based on a student network result of an implemented student network provided with an input, a sample corresponding to a distribution of an energy-based model based on the student network result and a teacher network result of an implemented teacher network provided with the input;
training model parameters of the energy-based model to decrease a value of the energy-based model, based on the teacher network result and the student network result; and
training the implemented student network to increase the value of the energy-based model, based on the sample and the student network result.

18. The apparatus of claim 17, wherein the training of the implemented student network comprises training the implemented student network to increase the value of the energy-based model based on the trained model parameters, based on the sample and the student network result.

19. The apparatus of claim 17, wherein the training of the model parameters and the training of the student network are repeatedly performed.

20. The apparatus of claim 19, wherein, while the training of the model parameters and the training of the implemented student network are repeatedly performed, the model parameters are trained based on another student network result of the trained student network provided with the input.

21. An apparatus, comprising:
one or more processors; and
a memory configured to store instructions,
wherein the one or more processors are configured to execute the instructions, which configures the one or more processors to perform:
applying an input to at least one image generation network; and
outputting an image based on the at least one image generation network,
wherein the at least one image generation network is trained by a knowledge distillation scheme using an energy-based model.

22. The apparatus of claim 21, wherein the at least one image generation network comprises:
a first type network trained by a first knowledge distillation scheme using the energy-based model; and
a second type network trained by a second knowledge distillation scheme using a Gaussian distribution.

23. The apparatus of claim 22, wherein each of the at least one image generation network is determined to be one of the first type network and the second type network based on either one or both of diversity of colors and textures comprised in an image generated by a corresponding image generation network.
